(19) United States
(12) Patent Application Publication
(10) Pub. No.: US 2015/0039373 A1
(43) Pub. Date: Feb. 5, 2015

(54) Method and Apparatus for Material Requirements Planning Adjustments

(71) Applicant: Motorola Mobility LLC, Libertyville, IL (US)

(72) Inventors: Abhishek Anand, Gurgaon (IN); Alok Anand, Gurgaon (IN); Gautam H. Kamdar, Singapore (IN)

(73) Assignee: Motorola Mobility LLC, Libertyville, IL (US)

(21) Appl. No.: 13/956,919

(22) Filed: Aug. 1, 2013

(51) Int. Cl. G06Q 10/06

(52) U.S. Cl. CPC G06Q 10/06312
USPC 705/7.22

(57) ABSTRACT

A method and apparatus provide material requirements planning adjustments. A system generated future material requirements planning value can be generated for at least one material for a product. An estimated future lifecycle requirements planning value can be determined for the at least one material. The system generated material requirements planning value can be compared with the estimated future lifecycle requirements planning value. The system generated future material requirements planning value can be adjusted based on comparing the system generated material requirements planning value with the estimated future lifecycle requirements planning value. A material requirements planning signal representing the adjusted system generated future material requirements planning value can be output.

### BACKGROUND

1. Field

The present disclosure is directed to a method and apparatus for material requirements planning adjustments. More particularly, the present disclosure is directed to generating a material requirements planning signal to order materials from a supplier for product production.

2. Introduction

Presently, enterprise resource planning systems use material requirements planning. Material requirements planning provides for production planning and inventory control that is used to manage manufacturing processes. A material requirements planning system ensures materials are available for production and products are available for delivery to customers, maintains the lowest possible material and product levels in store, and plans manufacturing activities, delivery schedules and purchasing activities. Producers and manufacturers use material requirements planning because customers desire the availability of products as quickly as possible.

Unfortunately, material requirements planning is subject to human intervention errors and system errors. These errors result in incorrect material requirements planning signals, such as purchase orders, to suppliers. For example, a producer often requests too many or too few materials from a supplier based on inaccurate material requirements planning signals. These errors result in problems, such as excess and obsolescence exposure to the producer, which result from too many or too little materials to produce a product to meet customer needs.

As a further example, fast moving technological industries involve demand that fluctuates and that is different from historical material requirements planning trends. Furthermore, industries, such as mobile phone industries, have product life cycles that are too short for typical material requirements planning. Furthermore, typical material requirements planning systems only provide guidance based on either historical trend changes or demand changes beyond a tolerance limit and do not provide accurate actual material requirements planning.

Thus, there is a need for a method and apparatus for material requirements planning adjustments.

### BRIEF DESCRIPTION OF THE DRAWINGS

In order to describe the manner in which advantages and features of the disclosure can be obtained, a description of the disclosure is rendered by reference to specific embodiments that are illustrated in the appended drawings. These drawings depict only example embodiments of the disclosure and are not therefore to be considered to be limiting of its scope.

FIG. 1 is an example block diagram of a system according to a possible embodiment;

FIG. 2 is an example flowchart illustrating a method of generating a material requirements planning signal according to a possible embodiment;

FIG. 3 is an example flowchart illustrating a method of generating a material requirements planning signal according to another possible embodiment;

FIG. 4 is an example flowchart illustrating a method of determining a lifecycle performance planning absolute percentage error value according to a possible embodiment;

FIG. 5 is an example flowchart illustrating a method of determining an estimated future lifecycle requirements planning value according to a possible embodiment;

FIG. 6 is an example flowchart illustrating a method of determining an estimated future lifecycle requirements planning value according to another possible embodiment;

FIG. 7 is an example illustration of a producer server according to a possible embodiment;

FIG. 8 is an example block diagram of system signals and outputs for different production units for a product according to a possible embodiment;

FIG. 9 is an example illustration of weeks that can be taken into account when generating material requirements planning signals according to a possible embodiment;

FIG. 10 is an example illustration of lifetime demand for a product according to a possible embodiment;

FIG. 11 is an example illustration of shipment amounts of a product according to a possible embodiment;

FIG. 12 is an example illustration of system generated material requirements planning values according to a possible embodiment;

FIG. 13 is an example illustration of estimated future lifecycle requirements planning values for a product and overstated and understated material requirements planning values according to a possible embodiment; and

FIG. 14 is an example illustration of adjusted system generated future material requirements planning values for system generated future material requirements planning signals according to a possible embodiment.

### DETAILED DESCRIPTION

Embodiments provide a method and apparatus for material requirements planning adjustments. A system generated future material requirements planning value can be generated for at least one material for a product. An estimated future lifecycle requirements planning value can be determined for the at least one material. The system generated material requirements planning value can be compared with the estimated future lifecycle requirements planning value. The system generated future material requirements planning value can be adjusted based on comparing the system generated material requirements planning value with the estimated future lifecycle requirements planning value. A material requirements planning signal representing the adjusted system generated future material requirements planning value can be output.

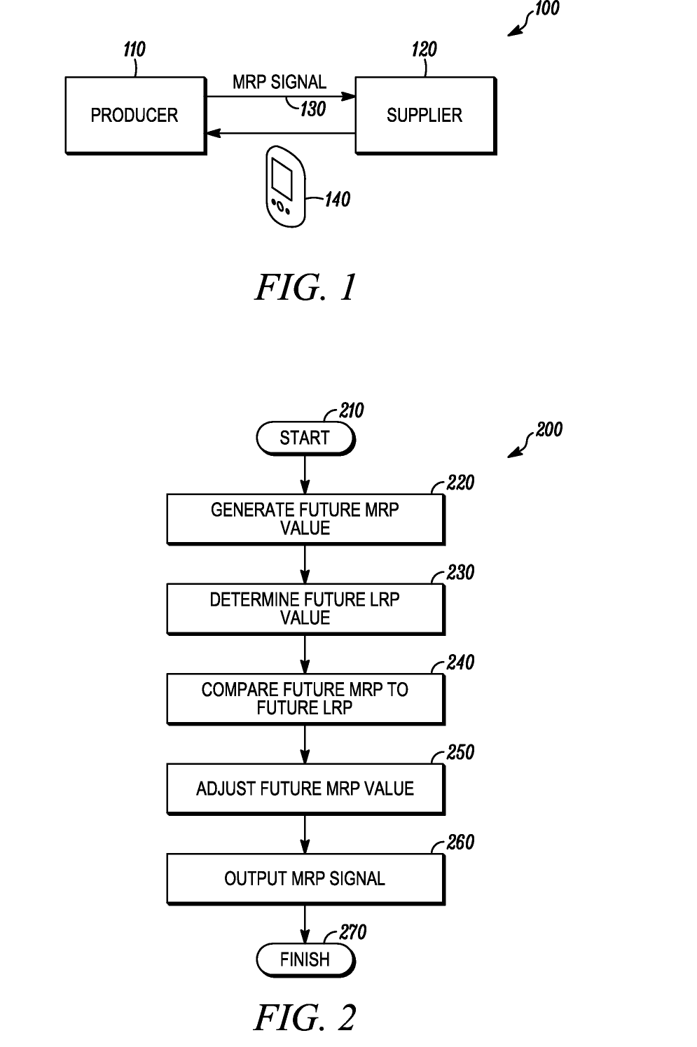

FIG. 1 is an example block diagram of a system 100 according to a possible embodiment. The system 100 can include a producer 110 and a supplier 120. The producer 110 can be a manufacturer, such as an electronic device manufacturer, a wireless communication device manufacturer, a semiconductor manufacturer, an automotive manufacturer, or other manufacturers. The producer 110 can also be a business, an intermediate supplier, a company, a factory, a corporate entity, a small business entity, or any other producer that can produce a product. In operation, the producer 110 can send a material requirements planning signal 130 to the supplier 120 or to other entities of the producer 110. The supplier 120 can supply materials 140 to the producer 110, to customers, to intermediate suppliers, or to other entities based on the material requirements planning signal 130. In another example operation, entities in the producer 110 can generate reports, generate purchase orders, produce products, provide information, or perform other operations based on the material requirements planning signal 130.

FIG. 2 is an example flowchart 200 illustrating an operation of generating a material requirements planning signal according to a possible embodiment. At 210, the method begins. At 220, a system generated future material requirements planning (MRP) value can be generated for at least one material for a product. The system generated future material requirements planning value can be generated based on a received requirements demand forecast value. For example, the system generated material requirements planning value for at least one material can be generated based on materials in transit from a supplier, based on on-hand inventory of the at least one material, based on future demand for the product over a time period, and/or based on other information. The system generated future material requirements planning value can represent required materials for a given future time period during the life of a product.

At 230, an estimated future lifecycle requirements planning value (LRP) can be determined for the at least one material. The estimated future lifecycle requirements planning value can represent material requirements for the future lifetime of the product. The estimated future lifecycle requirements planning value can be determined based on subtracting a lifetime shipment amount (LTS) of the material from a supplier of the material from a lifetime demand (LTD) amount of the material. For example, LRP=LTD−LTS. The LTD value can be the sum of LTD values over a time period, such as a number of weeks. The LTS value can be the sum of LTS values over a time period, such as a number of weeks. The lifetime can represent the lifetime of the product. The lifetime can also represent the lifetime of the product until a material requirements planning signal cutoff period when the material requirements planning signal is no longer sent to a supplier or no longer used. The lifetime shipment amount of the material can be an amount of material previously requested or shipped from the supplier. The lifetime demand amount of the material can be based on adding historical shipments, such as gross shipments (GS) of the product including the material over a previous time period, with future demand (F) for the product including the material over a future time period. For example, LTD=GS+F. The GS value can be the sum of gross shipments over a historical time period, such as a previous number of weeks. The future demand (F) value can be the sum of future demand over a time period, such as a number of future weeks. The estimated future lifecycle requirements planning value can be determined based on combining multiple estimated future lifecycle requirements planning values for different assembly types for the at least one material. The different assembly types can be different assembly types for materials for a product or can be different assembly types for the product.

At 240, the system generated material requirements planning value can be compared with the estimated future lifecycle requirements planning value. At 250, the system generated future material requirements planning value can be adjusted based on comparing the system generated material requirements planning value with the estimated future lifecycle requirements planning value. Alternately, the method may not adjust the system generated material requirements planning value if the system generated material requirements planning value is equal or close to the estimated future material requirements planning value.

At 260, a material requirements planning signal representing the adjusted system generated future material requirements planning value can be output. The output material requirements planning signal can be a signal sent to a supplier, can be a modified purchase order based on the adjusted system generated future material requirements planning value, can be a signal for a value displayed on a display, can be a printout of the adjusted system generated future material requirements planning value, can be a signal sent to other entities within or outside of a producer, or can be any other signal for a system generated future material requirements planning value. At 270, the method can end.

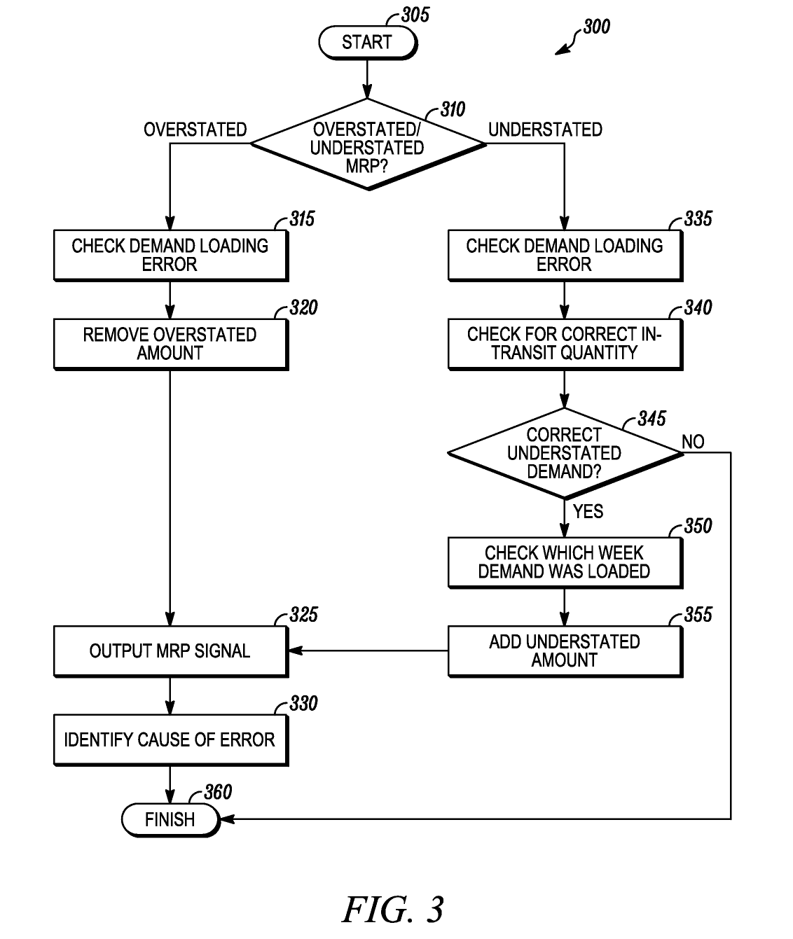

FIG. 3 is an example flowchart 300 illustrating a method of possible operations of generating a material requirements planning signal in response to comparing a system generated material requirements planning value with an estimated future lifecycle requirements planning value according to a possible embodiment. At 305, the method can begin. At 310, the method can ascertain whether the system generated future material requirements planning value is at least one of overstated and understated based on comparing a system generated future material requirements planning value with an estimated future lifecycle requirements planning value.

If the system generated future material requirements planning value is overstated, at 315, the method can check whether there was a demand loading error and output the information or use the information to improve the process. For example, the method can check whether there is an error in a requirements demand forecast value if the system generated material requirements planning value is one of overstated or understated. The method can then correct the requirements demand forecast value if there is an error, and adjust or regenerate the system generated future material requirements planning value based on the corrected demand value.

At 320, the system generated future material requirements planning value can be adjusted by removing the overstated amount. At 325, the system generated future material requirements planning value can be output. At 330, further causes of error can be identified and the process can be improved accordingly.

If the system generated future material requirements planning value is understated at 310, then at 335, the method can check whether there was a demand loading error and output the information or use the information to improve the process. At 340, correctness of an in-transit quantity of materials from a supplier can be checked and output and/or corrected, if necessary, to improve the process. At 345, the method can determine whether the understated system generated future material requirements planning value, such as demand, is correct, such as based on a demand loading error or based on the incorrect in-transit quantity. If the understated system generated future material requirements planning value is correct, at 350, the method can check which week the demand was loaded in the system for correction. At 355, the system generated future material requirements planning value can be adjusted by adding the understated amount. At 325, the system generated future material requirements planning value can be output. At 330, attempts can be made to identify causes of errors that resulted in overstated or understated system generated future material requirements planning values, such as based on demand loading, in-transit quantity, or week demand loading errors, and the process can be improved accordingly. At 360, the method can end.

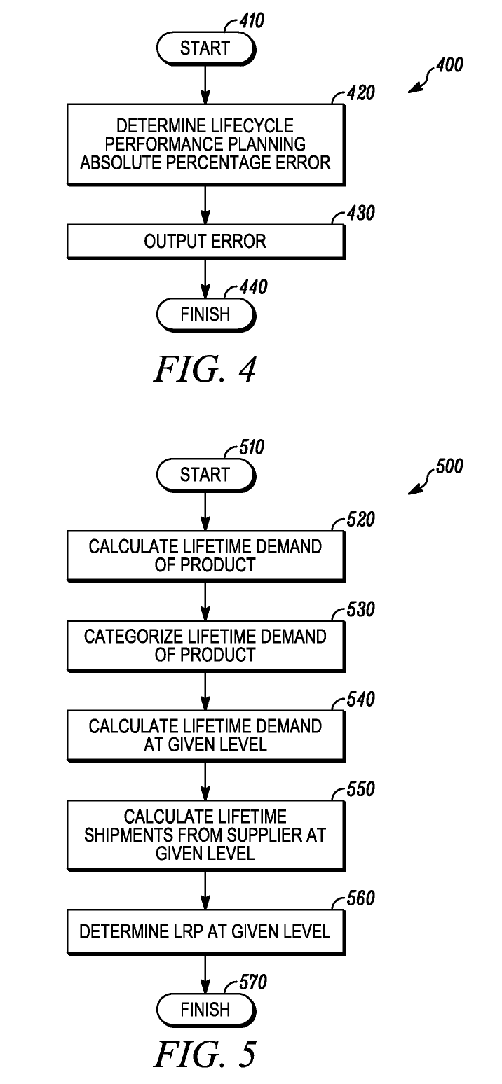

FIG. 4 is an example flowchart 400 illustrating a method according to a possible embodiment. At 410, the method can begin. At 420, a lifecycle performance planning absolute percentage error (LAPE) value can be determined. The lifecycle performance planning absolute percentage error value can be based on an overstated system generated future material requirements planning value (overstated MRP) that is based on comparing the system generated material requirements planning value (MRP) with the estimated future lifecycle requirements planning (LRP) value. The lifecycle performance planning absolute percentage error value can also be based on an understated system generated future material requirements planning value (understated MRP) that is based on comparing the system generated material requirements planning value with the estimated future lifecycle requirements planning value. The lifecycle performance planning absolute percentage error value can additionally be based on the estimated future lifecycle requirements planning value. The lifecycle performance planning absolute percentage error can further be based on adding the overstated system generated future material requirements planning value to the understated system generated future material requirements planning value and dividing the added values by the estimated future lifecycle requirements planning LRP value. For example, LAPE=(overstated MRP+understated MRP)/overall LRP. The overstated MRP can be the sum of overstated MRP values or the sum of absolute values of overstated MRP values over a time period, such as over a number of weeks. The understated MRP can be the sum of understated MRP values or the sum of absolute values of understated MRP values over a time period, such as over a number of weeks.

At 430, a lifecycle performance planning absolute percentage error signal based on the lifecycle performance planning absolute percentage error value can be output. For example, lifecycle performance planning absolute percentage error metrics can be published to monitor performance of system generated future material requirements planning simulations of the disclosed embodiments. Lifecycle performance planning absolute percentage error metrics can also be combined with other analysis and optimization elements of other embodiments to improve system generated future material requirements planning. At 440, the flowchart 400 can end.

FIG. 5 is an example flowchart 500 illustrating a method of determining an estimated future lifecycle requirements planning value according to a possible embodiment. At 510, the method can begin. At 520, a lifetime demand of a product can be calculated. For example, the lifetime demand amount of the material can be based on adding historical shipments of the product including the material to customers over a previous time period with future demand for the product including the material over a desired future time period. The desired further time period can be a planning horizon of a selected number of weeks into the future.

At 530, the lifetime demand of the product can be categorized. For example, the lifetime demand can be categorized into different material levels, such as into different assembly types, into different bills of materials, into different material colors, into different material types, into categories of materials for a product based on a supply planning model and/or into other categories of materials for a product. At 540, a lifetime demand for the product can be calculated at a given categorized material level. At 550, lifetime shipments of materials at the given categorized level can be calculated. At 560, an estimated future lifecycle requirements planning value can be determined at the given categorized materials level. For example, the estimated future lifecycle requirements planning value can be determined based on subtracting a lifetime shipment amount of the material from a supplier of the material from a lifetime demand amount of the material at the given categorized level. At 570, the method can end.

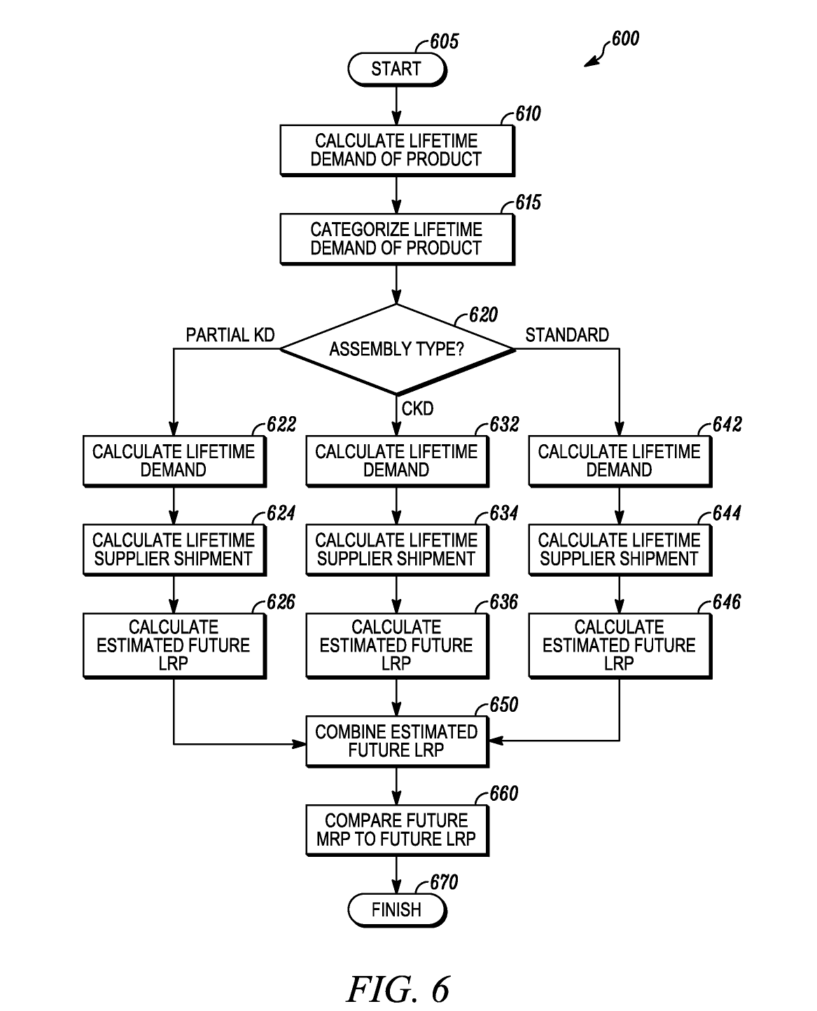

FIG. 6 is an example flowchart 600 illustrating a method of determining an estimated future lifecycle requirements planning value according to a possible embodiment. At 605, the method can begin. At 610, a lifetime demand of a product or material for the product can be calculated. For example, the lifetime demand amount of a material can be based on adding historical shipments of the product including the material to customers over a previous time period with future demand for the product including the material over a desired future time period. The desired further time period can be a planning horizon of a selected number of weeks into the future. At 615, the lifetime demand of the product can be categorized. In this example, the lifetime demand can be categorized into assembly types that can be based on a way that materials are received from a supplier.

At 620, assembly types for subsets of the materials can be determined. For example, separate estimated future lifecycle requirements planning values can be determined for different assembly types, such as partial knockdown assembly types, complete knockdown (CKD) assembly types, standard or finished goods assembly types, and/or other assembly types. The partial knockdown assembly types can include no knockdown (NKD) assembly types and semi-knockdown (SKD) assembly types. For example, materials from a supplier may not be completely assembled and different categories of knockdown assembly types can be based on a number of steps required for assembly.

At 622, 632, and 642, a lifetime demand for the product or materials can be calculated for different assembly types. At 624, 634, and 644, lifetime shipments of materials from suppliers can be calculated for different assembly types. At 626, 636, and 646, an estimated future lifecycle requirements planning value can be calculated for different assembly types. For example, the estimated future lifecycle requirements planning value can be determined based on subtracting a lifetime shipment amount of the material from a supplier of the material from a lifetime demand amount of the material for different assembly types. At 650, the estimated future lifecycle requirements planning values for the different assembly types can be combined. Each assembly type estimated future lifecycle requirements planning values can represent a percentage of the combined estimated future lifecycle requirements planning value.

At 660, a system generated material requirements planning value can be compared with the combined estimated future lifecycle requirements planning values, such as in step 240 of the flowchart 200, and additional steps of the flowchart 200 can be performed. Alternately, the estimated future lifecycle requirements planning values for the different assembly types may not be combined and different system generated material requirements planning values can be compared with the different estimated future lifecycle requirements planning values for the different assembly types. At 670, the method can end.

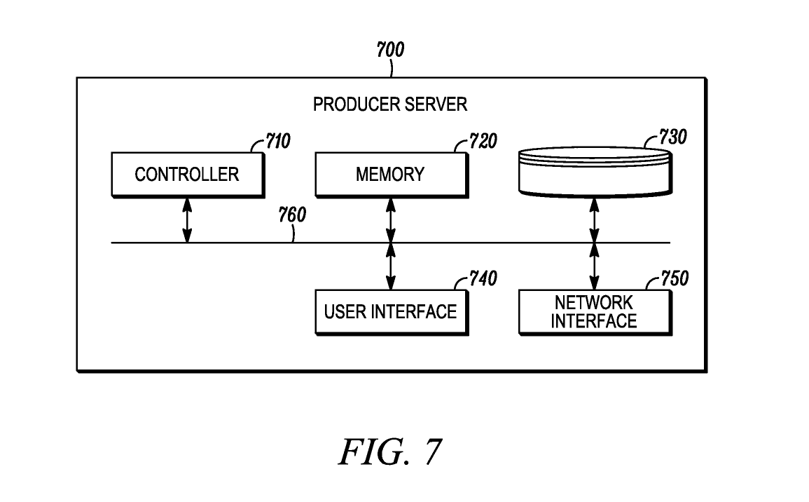

FIG. 7 is an example illustration of a producer server 700, such as a server at the producer 110, according to a possible embodiment. The producer server 700 can be an apparatus including a controller 710, a memory 720, a database interface 730, a user interface 740, and a network interface 750, all connected through a bus 760. The producer server 700 may implement any operating system, such as Microsoft Windows®, UNIX, or LINUX, or other operating systems to implement the operations described in the disclosed embodiments. Server software may be written in any programming language, such as C, C++, Java® or Visual Basic®, for example. Server software may run on an application framework, such as, for example, a Java® server or .NET® framework.

The controller 710 can be any programmed processor. However, operations can also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, controller 710 can be any device or devices that are capable of implementing the operations and methods described in the disclosed embodiments.

The memory 720 may include volatile and nonvolatile data storage, including one or more electrical, magnetic, or optical memories, such as a random access memory (RAM), a cache, a hard drive, a flash drive, or other memory devices. The memory 720 may also be connected to a Compact Disc-Read Only Memory (CD-ROM), a Digital Video Disc-Read Only Memory (DVD-ROM), a DVD read write input, a tape drive, or other removable memory device that allows media content to be directly uploaded into the producer server 700. The memory 720 may also be located at a remote location, such as over cloud storage. Data may be stored in the memory 720 or in a separate database. The database interface 730 may be used by the controller 710 to access the database.

The user interface 740 may be connected to one or more input and output devices that may include a keyboard, a mouse, a touch screen, speakers, a monitor, a voice-recognition device, a printer, or any other device that inputs and/or outputs data. The network interface 750 may be connected to a communication device, a modem, a network interface card, a transceiver, or any other device capable of transmitting and receiving signals from a network, another server, or any other device that transmits and receives signals. For example, the network interface 750 may be used to connect the producer server 700 to a server at the supplier 120. The components of the producer server 700 may be connected via an electrical bus 760, may be linked wirelessly or optically, or may be otherwise connected.

Client software and databases may be accessed by the controller 710 from memory 720, and may include, for example, database applications, spreadsheet applications, communication applications, as well as other components that provide for operation of the disclosed embodiments. Although not required, embodiments are described, at least in part, in the general context of computer-executable instructions, such as program modules, being executed by an electronic device, such as a general purpose computer. Generally, program modules can include routine programs, objects, components, and data structures that perform particular tasks or implement particular abstract data types. The program modules may be software-based and/or may be hardware-based. For example, the program modules may be stored on computer readable storage media, such as hardware discs, flash drives, optical drives, solid state drives, CD-ROM media, thumb drives, and other computer readable storage media that provide non-transitory storage aside from a transitory propagating signal. Moreover, embodiments may be practiced in network computing environments with many types of computer system configurations, including personal computers, hand-held devices, multi-processor systems, distributed computing systems, microprocessor-based or programmable consumer electronics, network personal computers, minicomputers, mainframe computers, and other computing environments.

In operation according to an example embodiment, the controller 710 can generate a system generated future material requirements planning value for at least one material for a product. According to a possible implementation, an input such as the user interface 740, the network interface 750, and/or the database interface 730, can receive a requirements demand forecast value. The requirements demand forecast value can be a demand forecast for a product that can include a requirements demand forecast for a current time period, such as a current week or month, and/or a future requirements demand forecast for a future time period, such as future weeks or months. The controller 710 can generate the system generated future material requirements planning value for at least one material for a product based on the requirements demand forecast value.

The controller 710 can determine an estimated future lifecycle requirements planning value for the at least one material. The controller 710 can compare the system generated material requirements planning value with the estimated future lifecycle requirements planning value. The controller 710 can adjust the system generated future material requirements planning value based on comparing the system generated material requirements planning value with the estimated future lifecycle requirements planning value. An output, such as the user interface 740, the network interface 750, and/or the database interface 730, can output a material requirements planning signal representing the adjusted system generated future material requirements planning value. The controller 710 can be further configured to implement other operations described in the disclosed methods.

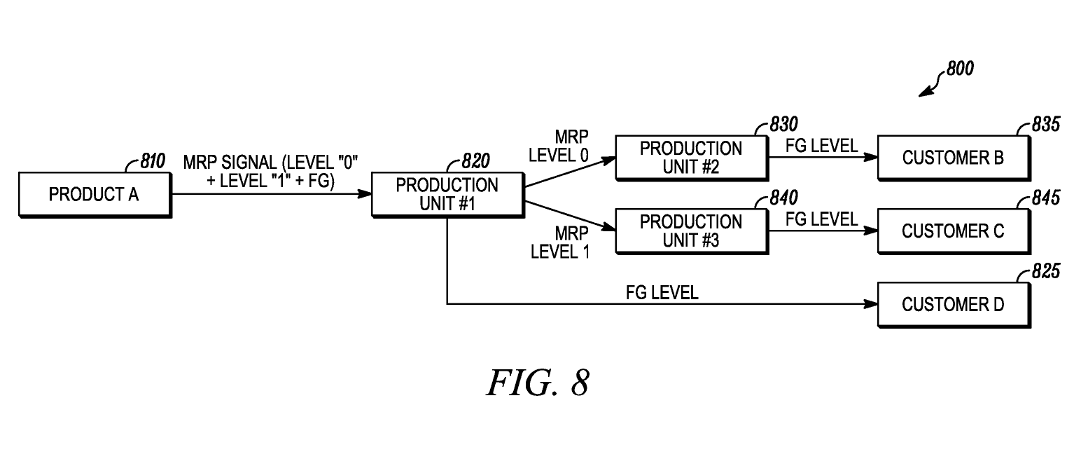

FIG. 8 is an example block diagram of system 800 signals, inputs, and outputs for different production units for a product from a producer 810, such as the producer 110, according to a possible embodiment. The system 800 can include the producer 810, a first production unit 820, a second production unit 830, a third production unit 840, a first customer 825, a second customer 835, and a third customer 845. According to a possible implementation, the production units 825, 835, and 845 can be central fulfillment centers. In operation, the producer 810 can send at least one material requirements planning signal to the first production unit 820. The material requirements planning signal can include amounts of different types of materials or products. For example, the material requirements planning signal can include amounts of products at different levels, such as a finished goods level and subcomponent levels, such as level 0 and level 1. The first production unit 820 can receive the material requirements planning signal and can produce and provide products at the finished goods level to the first customer 825. The first production unit 820 can also send a material requirements planning signal for level 0 materials to the second production unit 830 and a material requirements planning signal for level 1 materials to the third production unit 840. The second production unit 830 can provide finished goods to the second customer 835 based on the material requirements planning signal for level 0 materials. The third production unit 840 can provide finished goods to the third customer 845 based on the material requirements planning signal for level 1 materials.

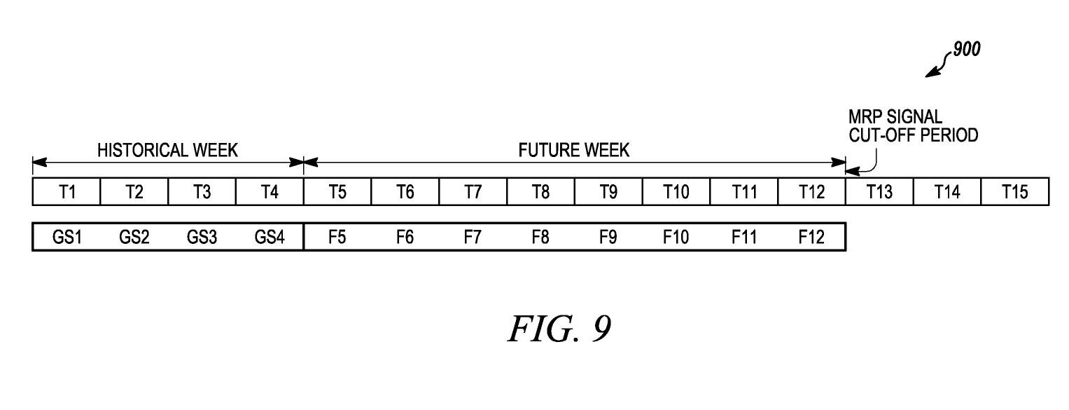

FIG. 9 is an example illustration of weeks 900 that can be taken into account when generating material requirements planning signals according to a possible embodiment. The weeks 900 can include historical weeks T1-T4 of gross shipments GS1-GS4 of products to customers. The weeks 900 can include future weeks T5-T12 of future demand F5-F12 for materials. The weeks 900 can also include future weeks T13-T15 at the end of a product lifecycle after material requirements planning signals are cut off or are no longer sent to suppliers.

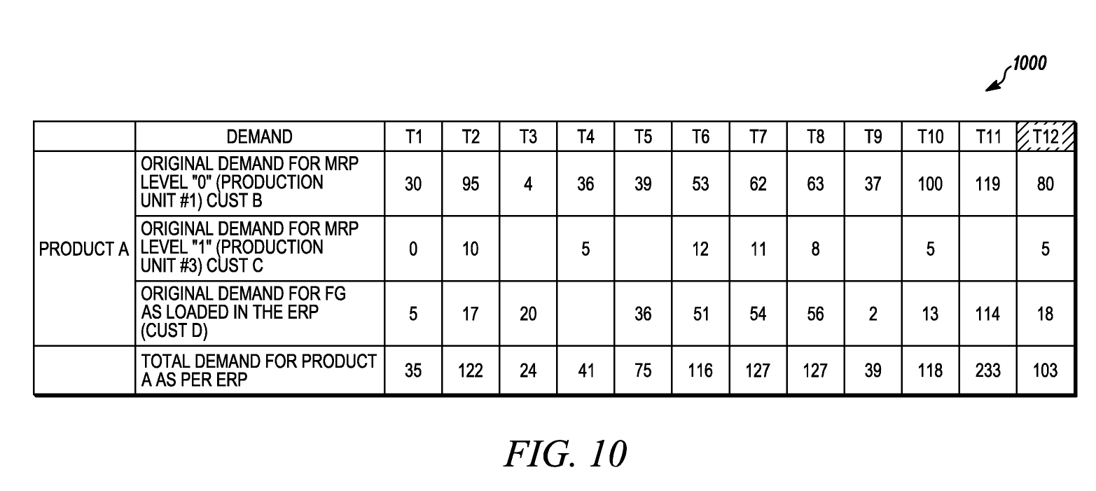

FIG. 10 is an example illustration of lifetime demand (LTD) 1000 for a product according to a possible embodiment. The lifetime demand 1000 for the product can be an original demand over a time period T1-T12 according to enterprise requirements planning for different production units, such as the first production unit 820, the second production unit 830, and the third production unit 840, and for the total demand for the product. The lifetime demand 1000 include historical demand over a time period T1-T4 and future demand over a time period T5-T12 for the first customer 825, the second customer 835, and the third customer 845.

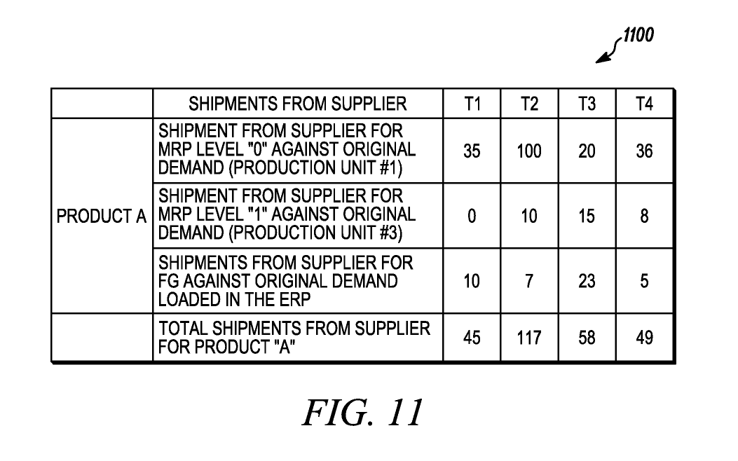

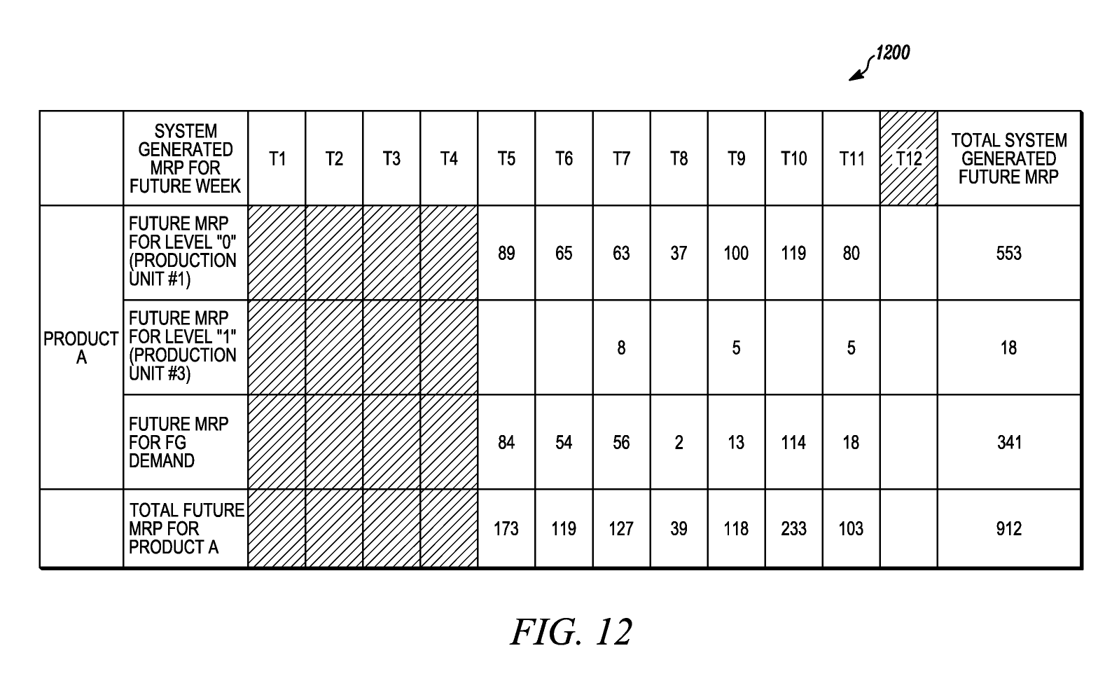

FIG. 11 is an example illustration of shipment amounts 1100 of a product according to a possible embodiment. The shipment amounts 1100 can be lifetime shipments (LTS) from a supplier over a time period T1-T12 according to enterprise requirements planning for the production units 820, 830, and 840 and for total shipments for the customers 825, 835, and 845.

FIG. 12 is an example illustration of system generated material requirements planning (MRP) values 1200 according to a possible embodiment. The system generated material requirements planning values 1200 can be for a future time period, such as weeks T5-T11 for level 0, level 1, and a finished goods level. The system generated material requirements planning values 1200 can include total future system generated material requirements planning values for each future week T5-T11 and system generated material requirements planning values over all of the future weeks T5-T11 for a product.

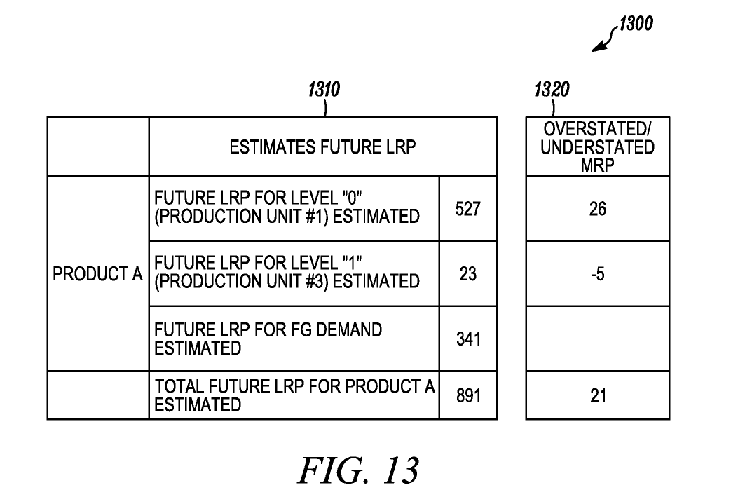

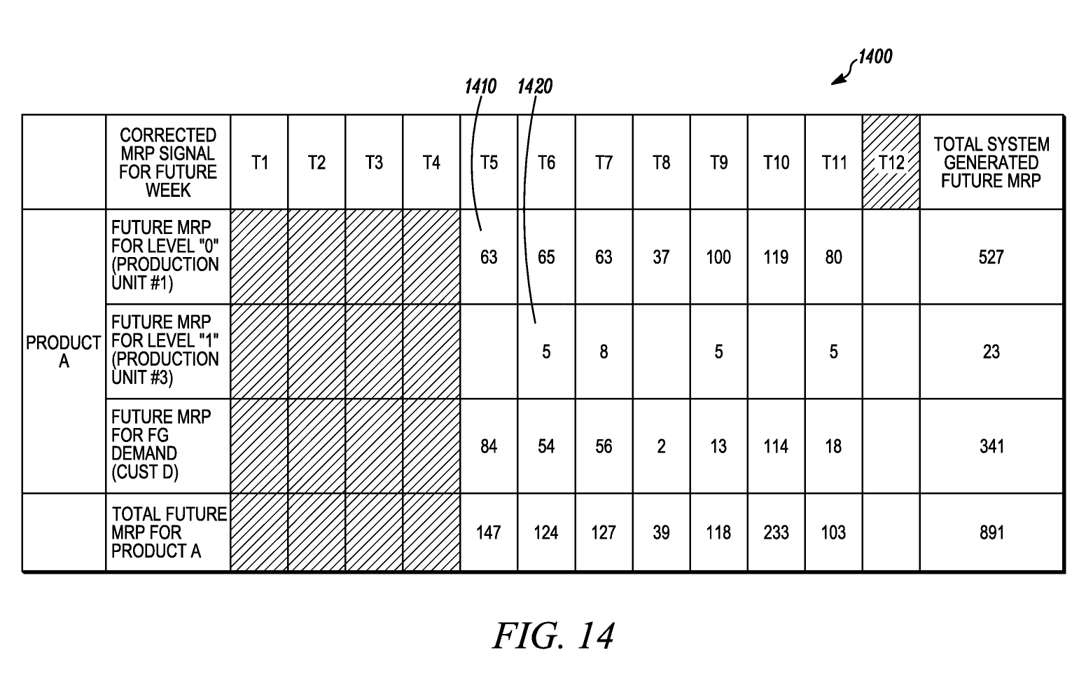

FIG. 13 is an example illustration 1300 of estimated future lifecycle requirements planning (LRP) values 1310 for a product and overstated and understated material requirements planning values 1320 according to a possible embodiment. The estimated future lifecycle requirements planning values 1310 can include estimated future lifecycle requirements planning values for different product levels and a total estimated future lifecycle requirements planning value. The overstated and understated material requirements planning values 1320 can be based on comparing the estimated future lifecycle requirements planning values 1310 with the total system generated material requirements planning values 1200 over all of the future weeks. For example, comparing the estimated future lifecycle requirements planning values 1310 with the total system generated material requirements planning values 1200 for level 0 products or materials can result in an overstated value of 26. Also, comparing the estimated future lifecycle requirements planning values 1310 with the total system generated material requirements planning values 1200 for level 1 products or materials can result in an understated value of 5.

FIG. 14 is an example illustration of adjusted, such as corrected, system generated future material requirements planning values 1400 for system generated future material requirements planning signals according to a possible embodiment. The adjusted system generated future material requirements planning values 1400 can be based on the overstated and understated material requirements planning values 1320. For example, the overstated material requirements planning value of 26 can be subtracted from a corresponding system generated material requirements planning value of 89 at week T5 to result in a value of 63 at 1410. The understated material requirements planning value can be added as a system generated material requirements planning value of 5 at 1420 at week T6.

According to some embodiments, a system generated material requirements planning value, such as a purchase order, can be created and the purchase order can be modified to give an adjusted purchase order value based on a lifetime plan for a product. Additionally, according to some embodiments, an enterprise resource planning engine can generate the system generated future material requirements planning value based on current demand, on hand stock, works in progress, in transit inventory, and other values. Embodiments can generate an estimated future lifecycle requirements planning value based on lifecycle requirements planning depending on a desired or utilized supply chain model. The system generated future material requirements planning value can be compared to the estimated future lifecycle requirements planning value and an overstated and/or understated material requirements planning error report can be published. Additionally, a lifecycle requirement panning absolute percentage error can be generated and published.

Some embodiments can provide an automated system to check the accuracy of a system generated material requirements planning outcome by using lifecycle time requirement planning. Embodiments can reduce employee resources required to check system generated material requirements planning simulations and can increase the consistency and accuracy of a system generated material requirements planning output based on lifecycle requirements planning analysis. Lifecycle performance planning absolute percentage error metrics can be published to monitor the overall performance of the system generated material requirements planning simulations. Embodiments can be applicable for any industry and can be applied to more than one situation, such as for other suppliers, multiple supply chain models, multi components models, and other situations.

It should be understood that, notwithstanding the particular steps as shown in the figures, a variety of additional or different steps can be performed depending upon the embodiment, and one or more of the particular steps can be rearranged, repeated or eliminated entirely depending upon the embodiment. Also, some of the steps performed can be repeated in an ongoing or continuous basis simultaneously while other steps are performed.

The method of this disclosure can be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, relational terms such as “first,” “second,” and the like may be used solely to distinguish one entity or action from another entity or action without necessarily requiring or implying any actual such relationship or order between such entities or actions. The phrase “at least one of” followed by a list is defined to mean at least one of but not necessarily all of the elements in the list. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

We claim:

1. A method comprising:
generating a system generated future material requirements planning value for at least one material for a product;
determining an estimated future lifecycle requirements planning value for the at least one material;
comparing the system generated material requirements planning value with the estimated future lifecycle requirements planning value;
adjusting the system generated future material requirements planning value based on comparing the system generated material requirements planning value with the estimated future lifecycle requirements planning value; and
outputting a material requirements planning signal representing the adjusted system generated future material requirements planning value.

2. The method according to claim 1, wherein determining comprises determining the estimated future lifecycle requirements planning value based on subtracting
a lifetime shipment amount of the material from a supplier of the material, from
a lifetime demand amount of the material.

3. The method according to claim 2, wherein the lifetime demand amount of the material is based on adding
historical shipments of the product including the material over a previous time period, with
future demand for the product including the material over a future time period.

4. The method according to claim 1, wherein generating comprises generating the system generated material requirements planning value for at least one material based on:
materials in transit from a supplier,
on-hand inventory of the at least one material, and
future demand for the product over a time period.

5. The method according to claim 1, further comprising ascertaining whether the system generated future material requirements planning value is at least one of overstated and understated based on comparing the system generated future material requirements planning value with the estimated future lifecycle requirements planning value,
wherein adjusting comprises adjusting the system generated future material requirements planning value if the system generated material requirements planning value is at least one of overstated and understated.

6. The method according to claim 5, further comprising:
checking whether there is an error in a requirements demand forecast value if the system generated material requirements planning value is one of overstated or understated; and
correcting the requirements demand forecast value if there is an error,
wherein adjusting comprises one of
adjusting the system generated future material requirements planning value based on the corrected demand value, and
regenerating the system generated future material requirements planning value based on the corrected demand value.

7. The method according to claim 1, further comprising:
determining a lifecycle performance planning absolute percentage error value based on:
an overstated system generated future material requirements planning value that is based on comparing the system generated material requirements planning value with the estimated future lifecycle requirements planning value,
an understated system generated future material requirements planning value that is based on comparing the system generated material requirements planning value with the estimated future lifecycle requirements planning value, and
the estimated future lifecycle requirements planning value; and
outputting a lifecycle performance planning absolute percentage error signal based on the lifecycle performance planning absolute percentage error value.

8. The method according to claim 7, wherein the lifecycle performance planning absolute percentage error is based on adding the overstated system generated future material requirements planning value to the understated system generated future material requirements planning value and dividing the added values by the estimated future lifecycle requirements planning value.

9. The method according to claim 1, wherein determining comprises determining an estimated future lifecycle requirements planning value based on combining multiple estimated future lifecycle requirements planning values for different assembly types for the at least one material.

10. An apparatus comprising:
a controller configured to generate a system generated future material requirements planning value for at least one material for a product, configured to determine an estimated future lifecycle requirements planning value for the at least one material, configured to compare the system generated material requirements planning value with the estimated future lifecycle requirements planning value, and configured to adjust the system generated future material requirements planning value based on comparing the system generated material requirements planning value with the estimated future lifecycle requirements planning value; and
an output configured to output a material requirements planning signal representing the adjusted system generated future material requirements planning value.

11. The apparatus according to claim 10, further comprising an input configured to receive a requirements demand forecast value,
wherein the controller is configured to generate the system generated future material requirements planning value for at least one material for a product based on the requirements demand forecast value.

12. The apparatus according to claim 10, wherein the controller is configured to determine the estimated future lifecycle requirements planning value based on subtracting:
a lifetime shipment amount of the material from a supplier of the material, from
a lifetime demand amount of the material.

13. The apparatus according to claim 12, wherein the lifetime demand amount of the material is based on adding:
historical shipments of the product including the material over a previous time period, with
future demand for the product including the material over a future time period.

14. The apparatus according to claim 10, wherein the controller is configured to generate the system generated material requirements planning value for at least one material based on:
materials in transit from a supplier,
on-hand inventory of the at least one material, and
future demand for the product over a time period.

15. The apparatus according to claim 10, wherein the controller is configured to ascertain whether the system generated future material requirements planning value is at least one of overstated and understated based on comparing the system generated future material requirements planning value with the estimated future lifecycle requirements planning value, and configured to adjust the system generated future material requirements planning value if the system generated material requirements planning value is at least one of overstated and understated.

16. The apparatus according to claim 15, wherein the controller is configured to
check whether there is an error in a requirements demand forecast value if the system generated material requirements planning value is one of overstated or understated,
correct the requirements demand forecast value if there is an error,
adjust the system generated future material requirements planning value by one of
adjusting the system generated future material requirements planning value based on the corrected demand value, and
regenerating the system generated future material requirements planning value based on the corrected demand value.

17. The apparatus according to claim 10,
wherein the controller is configured to determine a lifecycle performance planning absolute percentage error value based on:
an overstated system generated future material requirements planning value that is based on comparing the system generated material requirements planning value with the estimated future lifecycle requirements planning value,
an understated system generated future material requirements planning value that is based on comparing the system generated material requirements planning value with the estimated future lifecycle requirements planning value, and
the estimated future lifecycle requirements planning value; and
wherein the controller is configured to output a lifecycle performance planning absolute percentage error signal based on the lifecycle performance planning absolute percentage error value.

18. The apparatus according to claim 17, wherein the lifecycle performance planning absolute percentage error is based on adding the overstated system generated future material requirements planning value to the understated system generated future material requirements planning value and dividing the added values by the estimated future lifecycle requirements planning value.

19. The apparatus according to claim 10, wherein the controller is configured to determine the estimated future lifecycle requirements planning value based on combining multiple estimated future lifecycle requirements planning values for different assembly types for the at least one material.

20. A method comprising:
receiving a requirements demand forecast value;
generating a system generated future material requirements planning value for at least one material for a product based on the requirements demand forecast value;
determining an estimated future lifecycle requirements planning value for the at least one material;
comparing the system generated material requirements planning value with the estimated future lifecycle requirements planning value;
adjusting the system generated future material requirements planning value based on comparing the system generated material requirements planning value with the estimated future lifecycle requirements planning value; and
outputting a purchase order including the adjusted system generated future material requirements planning value.
